(19) United States
(12) Patent Application Publication
(10) Pub. No.: US 2018/0338025 A1
(43) Pub. Date: Nov. 22, 2018

(54) DISTRACTED DRIVER DETECTION AND NOTIFICATION SYSTEM

(71) Applicant: GM GLOBAL TECHNOLOGY OPERATIONS LLC, DETROIT, MI (US)

(72) Inventors: Timothy J. TALTY, Beverly Hills, MI (US); Gregg R. KITTINGER, Oakland Township, MI (US); David R. PETRUCCI, Warren, MI (US)

(21) Appl. No.: 15/598,746

(22) Filed: May 18, 2017

(51) Int. Cl. H04M 1/60; H04M 1/725; H04N 7/18; G06K 9/00; G06K 9/62; G10L 25/48; G10L 25/78

(52) U.S. Cl. CPC H04M 1/6091; H04M 1/7253; H04N 7/183; H04M 2201/40; G06K 9/6267; G10L 25/48; G10L 25/78; G06K 9/00845

(57) ABSTRACT

A method includes determining, with an on-board vehicle hardware system, if an active cellular phone call is occurring. The method also includes determining, with a vehicle infotainment system, if a hands-free call system is in use when an active cellular phone call is established. A notification is then provided, through the vehicle infotainment system, when it is determined that the hands-free call system is not in use. The notification provides a vehicle operator with instruction for activating the hands-free call system for a future usage.

### FIELD

The present disclosure relates generally to driver assistance systems, and more particularly to a distracted driver detection and notification system.

### INTRODUCTION

The statements in this section merely provide background information related to the present disclosure and may not constitute prior art.

Many modern vehicles include sophisticated electronic systems designed to increase the safety, comfort and convenience of the occupants. Among these systems are wireless technologies embedded so as to provide hands-free capabilities for vehicle occupants. While technologically savvy individuals are drawn to and significantly make use of the plethora of electronic systems in a vehicle, such as wireless technology, older and less skilled individuals may not be aware of or may struggle to utilize these systems.

### SUMMARY

A method includes determining, with an on-board vehicle hardware system, if an active cellular phone call is occurring. The method also includes determining, with a vehicle infotainment system, if a hands-free call system is in use when an active cellular phone call is established. A notification is then provided, through the vehicle infotainment system, when it is determined that the hands-free call system is not in use. The notification provides a vehicle operator with instruction for activating the hands-free call system for a future usage.

A computer-implemented method for detecting and notifying of a non-hands-free cellular call within a vehicle includes detecting, via an on-board vehicle hardware system, the occurrence of an active cellular phone call. A vehicle controller may be used to detect a usage of a hands-free call system during the occurrence of the active cellular phone call. The vehicle controller may also be used to determine if the active cellular phone call was placed using the hands-free call system. An infotainment system is then used to notify a failure to utilize the hands-free call system for the active cellular phone call.

A method includes determining, via an on-board vehicle hardware system, if an active cellular phone call is occurring. The method also includes determining, via a vehicle controller, a usage of a hands-free call system during the occurrence of the active cellular phone call. A notification is then provided through a remote system when it is determined that the hands-free call system is not in use.

In some embodiments, the on-board vehicle hardware system is a broadband antenna and detection circuit embedded within a vehicle seat. The broadband antenna and detection circuit can further include a passive antenna structure arranged within a headrest of the vehicle seat and it can be used to detect a radio frequency signal change indicating that a cellular phone is in use. Furthermore, the on-board vehicle hardware system may also be an interior microphone system that performs an audio signal process to detect and classify speech patterns consistent with a cellular phone usage. In addition, the on-board vehicle hardware system can be a cabin-view camera system that performs a camera and video signal process to detect and classify driver motions consistent with the active cellular phone call.

In other embodiments, the notification provides a vehicle operator with instruction for activating the hands-free call system for a future usage. The notification may be provided to a vehicle owner via a remote device. Furthermore, the on-board vehicle hardware system is at least one of a broadband antenna and detection circuit embedded within a vehicle seat, an interior microphone system arranged within a vehicle cabin, or a cabin-view camera system.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a vehicle interior according to the present disclosure;

FIG. 2 is a perspective view of a vehicle seat having an embedded hardware system;

FIG. 3 is a block diagram for an exemplary detection and notification algorithm using the embedded hardware system of FIG. 2;

FIG. 4 is a perspective view of a vehicle interior having an interior microphone system and a cabin-view camera system; and

FIG. 5 is a block diagram for another exemplary detection and notification algorithm using the interior microphone system and cabin-view camera system of FIG. 4.

### DETAILED DESCRIPTION

The following description is merely exemplary in nature and is not intended to limit the present disclosure, application, or uses. Furthermore, there is no intention to be bound by any expressed or implied theory presented in the preceding field, introduction, summary or the following detailed description. It should be understood that throughout the drawings, corresponding reference numerals indicate like or corresponding parts and features. Further, directions such as “top,” “side,” “back”, “lower,” and “upper” are used for purposes of explanation and are not intended to require specific orientations unless otherwise stated. These directions are merely provided as a frame of reference with respect to the examples provided, but could be altered in alternate applications. Conventional techniques and components related to vehicle electrical and mechanical parts and other functional aspects of the system (and the individual operating components of the system) may not be described in detail herein for the sake of brevity. It should be noted, however, that many alternative or additional functional relationships or physical connections may be present in an embodiment of the invention.

Additionally, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The following description also refers to elements or features being “connected” or “coupled” together. As used herein, these terms refer to one element/feature being directly or indirectly joined to (or directly or indirectly communicating with) another element/feature, but not necessarily through mechanical means. Furthermore, although the schematic diagrams shown herein depict example arrangements of elements, additional intervening elements, devices, features, or components may be present in an actual embodiment.

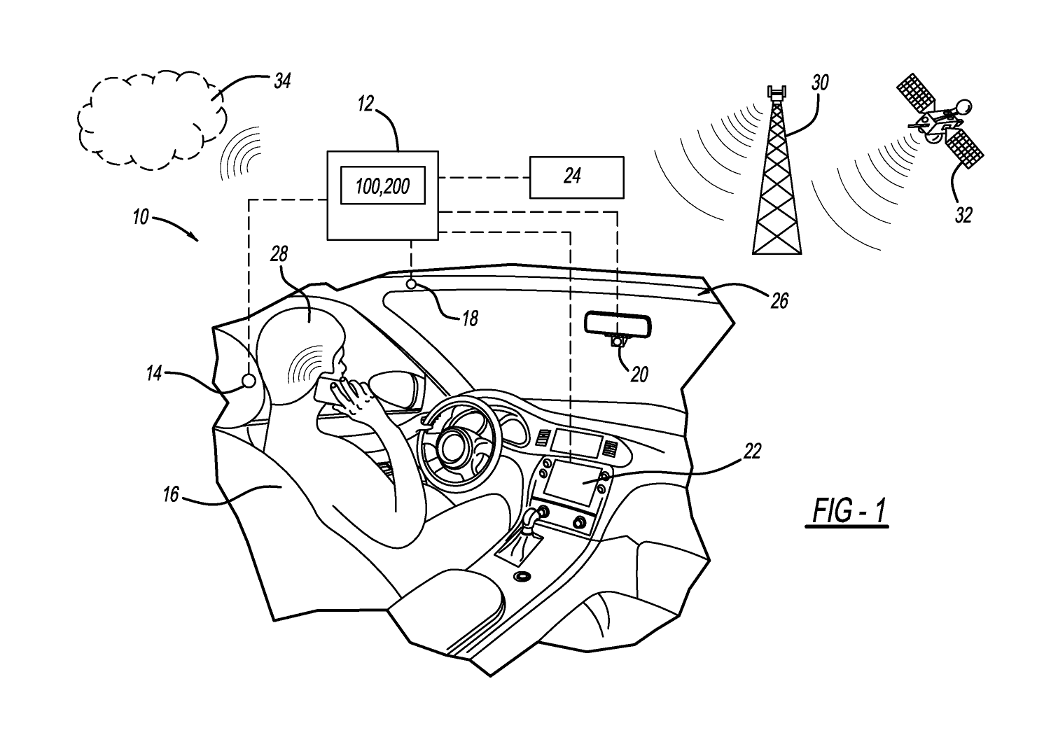

With reference now to FIG. 1, an exemplary vehicle 10 is shown having an electronic control unit (ECU) 12 communicating with a broadband antenna and detection circuit 14 embedded within a vehicle seat 16, an interior microphone system 18 having at least one microphone, a cabin-view camera system 20 having at least one camera, and an infotainment system 22. The ECU 12 may also communicate with other vehicle systems 24, including but not limited to, a cruise control system, a collision warning system, a collision mitigation braking system, an auto cruise control system, a lane departure warning system, a lane keep assist system, a navigation system, and various other vehicle sensors arranged inside a vehicle cabin 26.

The ECU 12 may further incorporate a detection and notification algorithm 100, 200 that may be used to detect the presence of an active cellular phone call, by a vehicle driver 28, without the use of the vehicle's hands-free technologies. The detection and notification algorithm 100, 200 may also be used to inform the vehicle driver 28 or other interested party (e.g., parent) of the behavior, with optional assistance for activating the hands-free technologies. In this regard, the ECU 12 may also communicate with external sources (e.g., with a remote wireless communications system 30 and/or with a remote satellite system 32). The ECU 12 monitors and processes available information from the aforementioned sources, including information available from the remote systems 30, 32 regarding the external environment (e.g., local ordinances, driving conditions). While the functions of the detection and notification algorithm 100, 200 are described as being completed within the ECU 12 (e.g., on-board), the processing steps may also be completed at a remote location (e.g., server 34).

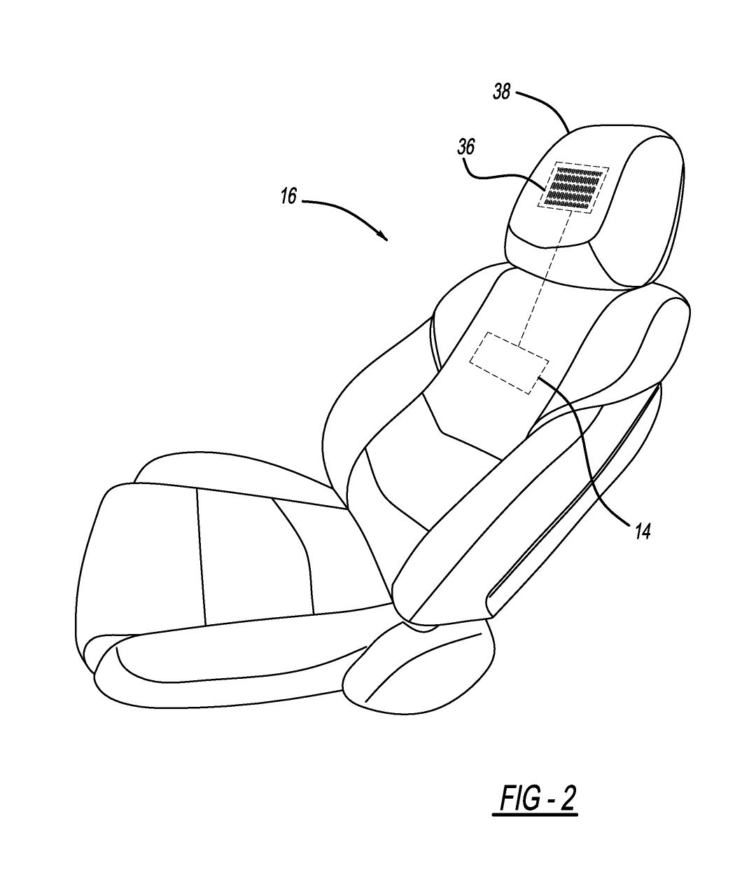

Referring now to FIG. 2, a first exemplary embodiment utilizes the broadband antenna and detection circuit 14 embedded within the vehicle seat 16 to perform a radio frequency detection of an active cellular phone call. In particular, the broadband antenna and detection circuit 14 may have a coil feature 36 arranged within a headrest 38 of the vehicle seat 16. The coil feature 36 may operate as a passive antenna structure. While described as being located within the vehicle seat 16, and particularly within the headrest 38, it should be understood that the coil feature 36 of the broadband antenna and detection circuit 14 may be arranged anywhere within the vehicle cabin 26 (e.g., within an upper portion of seatback, a headliner, a B-pillar, a door frame, and/or a sun visor) in order to adequately and consistently determine the presence of an active cellular phone call by the vehicle driver 28.

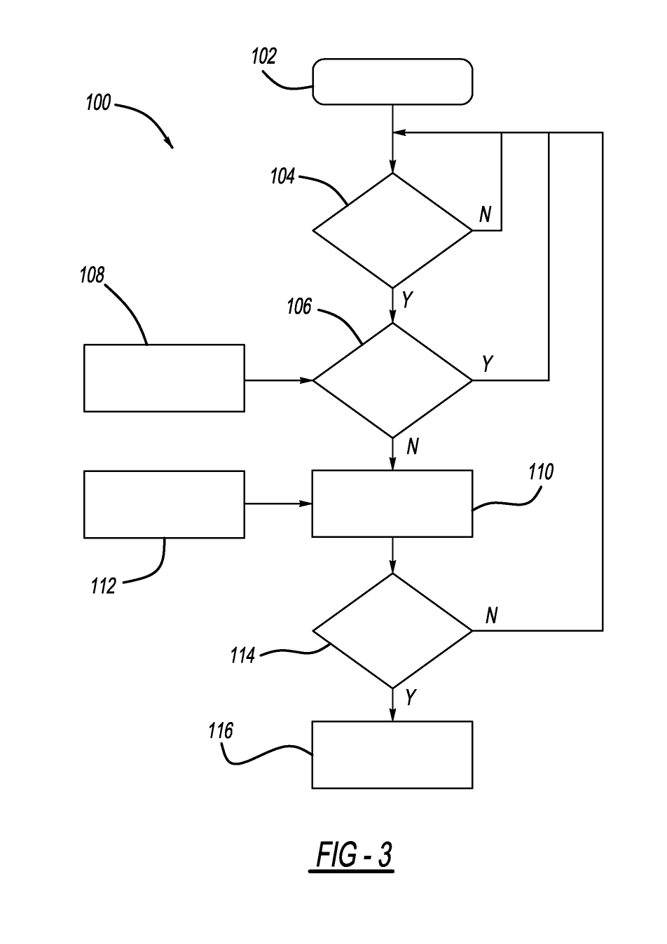

When the vehicle 10 is in motion, the ECU 12 may initiate the detection and notification algorithm 100 (Step 102) as shown in FIG. 3. While the detection and notification algorithm 100 is described as being initiated by vehicle motion, it may also be initiated by other vehicular operations (e.g., initiated upon vehicle start). At step 104, the broadband antenna and detection circuit 14 determines if the vehicle driver 28 is in a cellular call through a radio frequency (RF) detection. The broadband antenna and detection circuit 14 detects a RF signal change indicating that the vehicle driver 28 is using a cellular phone. If no RF signal change is detected, the process continues in a loop until a RF signal change is detected. Once a RF signal change is detected, the process continues to Step 106 where a determination is made whether the vehicle driver 28 is in an active hands-free call. This determination of an active hands-free call may be ascertained through inputs 108 from the various vehicle systems 24. As an example only, the vehicle infotainment system 22 may provide an indication that the vehicle BLUETOOTH system has an active connection with a cellular phone in the vehicle 10. As another example, the cabin-view camera system 20 may be used to verify if both driver hands are located on the vehicle steering wheel (e.g., if both hands are on wheel, it is unlikely that the driver is in a non-hands free call).

If the vehicle driver 28 is determined to be utilizing the hands-free mode for the cellular call, the process loops back to the beginning. If, however, the hands-free mode is determined to not be in use, the process continues to Step 110 where a notification function is activated. The notification function may receive inputs 112 relating to the state of the vehicle 10 and to the preferences of the vehicle driver 28. As an example only, the vehicle driver 28 may prefer to preemptively cancel any and all notifications (e.g., through an initial “no notification requested” option during infotainment setup). Alternately, the vehicle driver 28 may request notification through various methods (e.g., email, audio, visual). It is also understood that a vehicle owner (not necessarily the vehicle driver 28) may also enable notifications when any driver is placing a non-hands-free cellular phone call (e.g., parent may request a teen driver alert to be displayed in vehicle or transmitted to parent when the teen driver places a cellular telephone call without using the hands-free mode). In the instance where a vehicle owner enables notifications, there may also be provided an ability to lock or override any opting out of instruction for vehicle drivers (e.g., parental ability to override teenager opting out of notifications). At an appropriate time and mode (e.g., when the vehicle is in “park” or no longer moving), the algorithm 100 may proceed to inform the vehicle driver 28 that the vehicle 10 has hands-free calling capabilities and offer to provide the vehicle driver 28 with instructions for how to use the feature.

When prompted for additional assistance at Step 114, the vehicle driver 28 may choose to decline assistance. In this case, the algorithm may again restart and continue in a loop until another RF signal change is detected. If, however, the vehicle driver 28 chooses to accept the feature assistance, a tutorial on using the hands-free capabilities will be initiated at Step 116. In this way, the vehicle driver 28 can be prompted to interact with the vehicle's infotainment system 22 and can be assisted in establishing the hands-free call capabilities, which reduce driver distraction and improve driver satisfaction. As previously discussed, the detection and notification algorithm 100 may also be preset to inform the vehicle's owner of other vehicle driver's behaviors. Notably, the detection and notification algorithm 100 can also inform the vehicle driver 28 of possible local restrictions, thereby leveraging the vehicle's global positioning systems (e.g., via the remote wireless communications system 30 and/or the remote satellite system 32) in combination with local ordinances.

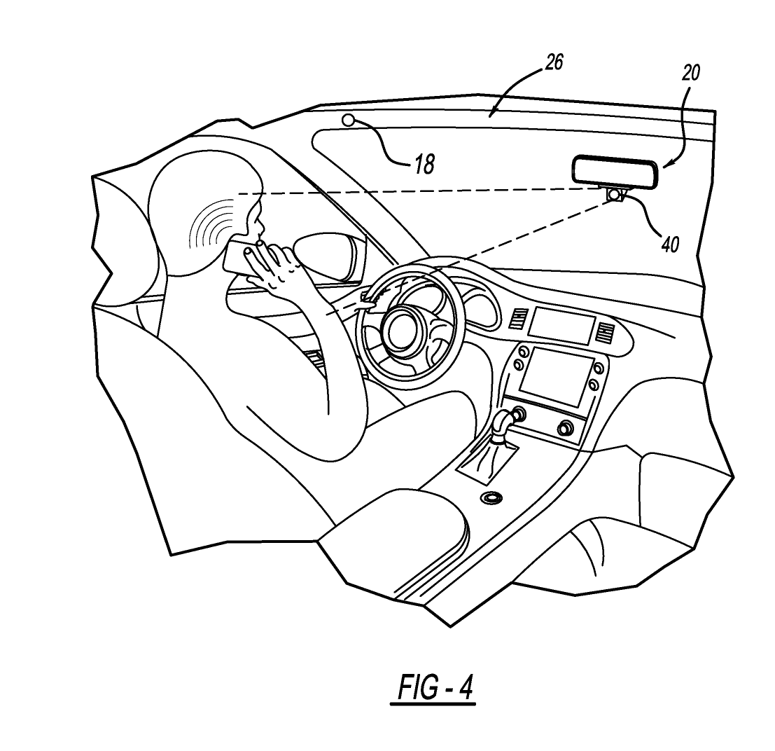

With reference now to FIG. 4, another exemplary embodiment utilizes the vehicle's interior microphone system 18 and/or the cabin-view camera system 20 to detect the presence of an active cellular phone call. In particular, either the interior microphone system 18 or the cabin-view camera system 20, alone or in combination, may be leveraged to track the presence of a cellular telephone at an in-use position with respect to the vehicle driver 28 (i.e., for determination of an active call). When leveraging the existing vehicle microphone hardware, an audio signal process can be used to detect and classify speech patterns (e.g., identify that the vehicle driver 28 is in a one-sided conversation).

In the alternative or in addition, at least one camera 40 of the cabin-view camera system 20 can generate frames of image data at a certain data frame rate that can be stored for subsequent image processing. In some hardware embodiments, the image processing can be performed in a video processing module that may be a stand-alone unit or integrated circuit or may be incorporated into the ECU 12. Alternatively in software embodiments, the video processing module may represent a video processing software routine that is executed by the ECU 12. The camera image data can be used to generate an interior view of the vehicle cabin 26, and in particular, of the vehicle driver 28, using the images from the cabin-view camera system 20. When more than one camera is used, the image data can be stitched together with an algorithm that employs rotation matrices and translation vectors to orient and reconfigure the images from adjacent cameras so that the images properly overlap. The reconfigured images can then be used to check the internal environment of the vehicle 10 for further consideration in the ECU 12. The camera(s) 40 may be any type of camera suitable for the purposes described herein and should not be limited to only standard cameras presently available on automotive vehicles, for example, cameras capable of receiving light or other radiation and converting the energy to electrical signals in a pixel format using charged coupled devices. The camera image data can then be paired with audio cues received from the vehicle's interior microphone system 18 to adequately and consistently determine the presence of an active cellular phone call by the vehicle driver 28.

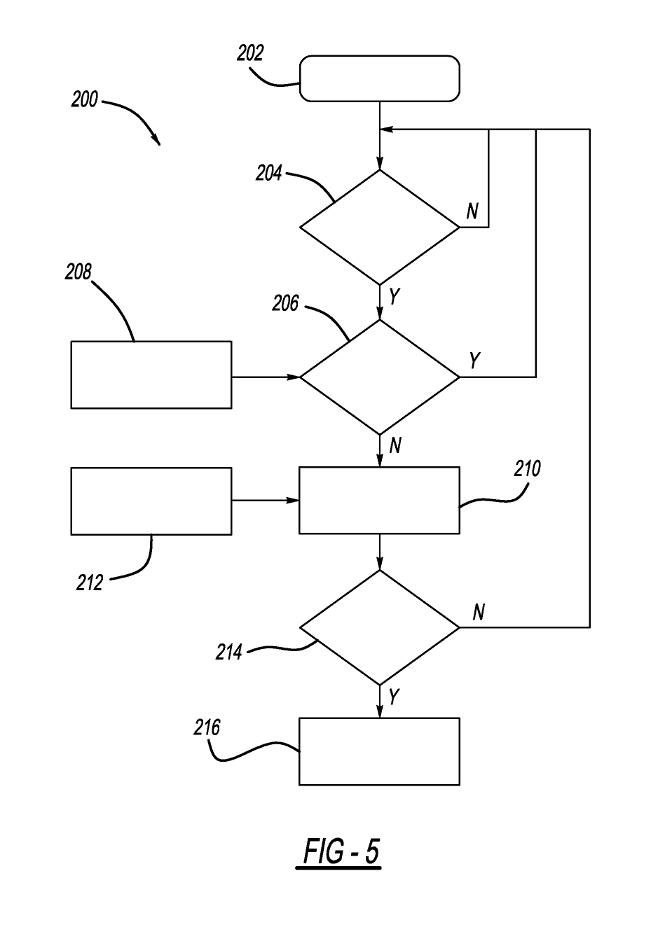

Referring now to FIG. 5, the ECU 12 may initiate the detection and notification algorithm 200 (Step 202) when the vehicle 10 is in motion. While the detection and notification algorithm 200 is described as being initiated by vehicle motion, it may also be initiated by other vehicular operations (e.g., initiated upon vehicle start). At step 204, the vehicle's interior microphone system 18 and/or the cabin-view camera system 20 may be leveraged to determine if the vehicle driver 28 is in a cellular call through the vehicle microphone and audio signal processing and/or through camera and video signal processing. The microphone 18 and/or camera 20 systems detect auditory and/or image signal changes indicating that the vehicle driver 28 is using a cellular phone. If no auditory and/or image signal change is detected, the process continues looping until an auditory and/or image signal change is detected. Once a signal change is detected, the process continues to Step 206 where a determination is made whether the vehicle driver 28 is in an active hands-free call. This determination of an active hands-free call may be ascertained through inputs 208 from the various vehicle systems 24, as previously discussed with respect to the algorithm 100.

If the vehicle driver 28 is determined to be utilizing the hands-free mode for the cellular call, the process loops back to the beginning. If, however, the hands-free mode is determined to not be in use, the process continues to Step 210 where a notification step is activated. The notification step may receive inputs 212 relating to the state of the vehicle 10 and to the preferences of the vehicle driver 28. As previously noted, the vehicle driver 28 may preemptively cancel notifications or may request notification through any of various methods. In addition, a vehicle owner may also enable notifications when any vehicle driver is placing a non-hands-free cellular phone call.

At an appropriate time and mode (e.g., when the vehicle is in “park” or no longer moving), the algorithm 200 may proceed to inform the vehicle driver 28 that the vehicle 10 has hands-free calling capabilities and offer to provide the vehicle driver 28 with instructions for how to use the feature. When prompted for additional assistance at Step 214, the vehicle driver 28 may choose to accept or decline assistance. With a decline, the algorithm 200 may restart and loop until another signal change is detected. If, however, the vehicle driver 28 chooses to accept feature assistance, a tutorial on using the hands-free capabilities will be initiated at Step 216. In this way, the vehicle driver 28 can be prompted to interact with the vehicle's infotainment system 22 and can be assisted in establishing the hands-free call capabilities. As previously discussed, the detection and notification algorithm 200 may also be preset to inform the vehicle's owner of other vehicle driver's behaviors and can also inform the vehicle driver 28 of possible local restrictions, thereby leveraging the vehicle's global positioning system in light of local ordinances.

It should be understood that other methods may be used to identify to presence of a non-hands free call. As another example, the active safety feature, lane keep assist, active braking, or the like may be used to ascertain erratic or distracted driving behaviors related to non-hands free calls.

As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for various applications. Various combinations and modifications of the features consistent with the teachings of this disclosure, however, could be desired for particular applications or implementations. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

Embodiments of the present disclosure are described herein. This description is merely exemplary in nature and, thus, variations that do not depart from the gist of the disclosure are intended to be within the scope of the disclosure. For example, the disclosure may also be utilized in non-automotive environments where a distracted operator notification system is beneficial, such as with industrial equipment.

1. A method comprising:
determining, with a broadband antenna and detection circuit embedded within a headrest of a vehicle seat, if an active cellular phone call is occurring;
determining, with a vehicle infotainment system, if a hands-free call system is in use when an active cellular phone call is established; and
providing a notification, through the vehicle infotainment system, when it is determined that the hands-free call system is not in use, wherein the notification provides a vehicle operator with instruction for activating the hands-free call system for a future usage.

2. (canceled)

3. The method of claim 1, wherein the broadband antenna and detection circuit further includes a passive antenna structure arranged within the vehicle seat.

4. The method of claim 1, wherein the broadband antenna and detection circuit detects a radio frequency signal change indicating that a cellular phone is in use.

5. (canceled)

6. (canceled)

7. (canceled)

8. (canceled)

9. A computer-implemented method for detecting and notifying of a non-hands-free cellular call within a vehicle, comprising:
detecting, via a broadband antenna and detection circuit embedded within a headrest of a vehicle seat, the occurrence of an active cellular phone call;
detecting, via a vehicle controller, a usage of a hands-free call system during the occurrence of the active cellular phone call;
determining, in the vehicle controller, if the active cellular phone call was placed using the hands-free call system; and
notifying, via an infotainment system, a failure to utilize the hands-free call system for the active cellular phone call.

10. (canceled)

11. The method for detecting and notifying of a non-hands-free cellular call of claim 9, wherein the broadband antenna and detection circuit further includes a passive antenna structure arranged within the vehicle seat.

12. The method for detecting and notifying of a non-hands-free cellular call of claim 9, wherein the broadband antenna and detection circuit detects a radio frequency signal change indicating that a cellular phone is in use.

13. (canceled)

14. (canceled)

15. (canceled)

16. (canceled)

17. A method comprising:
determining, via a broadband antenna and detection circuit embedded within a headrest of a vehicle seat, if an active cellular phone call is occurring;
determining, via a vehicle controller, a usage of a hands-free call system during the occurrence of the active cellular phone call; and
providing a vehicle operator with an instruction for activating the hands-free call system for a future usage, through a remote system, when it is determined that the hands-free call system is not in use.

18. (canceled)

19. The method of claim 17, wherein the notification is provided to a vehicle owner via a remote device.

20. (canceled)
